(19) United States
(12) Patent Application Publication
(10) Pub. No.: US 2011/0295747 A1
(43) Pub. Date: Dec. 1, 2011

(54) SYSTEM FOR REMOTELY MANAGING AN ONGOING FINANCIAL TRANSACTION

(76) Inventor: Cicero Antonio Xavier De Tortelli, Sao Paulo (BR)

(21) Appl. No.: 13/161,196

(22) Filed: Jun. 15, 2011

Related U.S. Application Data
(63) Continuation-in-part of application No. 12/162,257, filed on Jun. 1, 2009, now abandoned.

(51) Int. Cl. G06Q 20/00; G06Q 30/00

(52) U.S. Cl. 705/42

(57) ABSTRACT

The system for remotely managing an ongoing financial transaction providing the necessary comfort and speed for the customer, enabling a reactive or passive operations action from a registered remote customer, the customer requested to authorize or refuse a financial transaction request being processed.

### CROSS-REFERENCE TO RELATED APPLICATIONS

The present application is a Continuation In Part of U.S. application Ser. No. 12/162,257, filed Jun. 1, 2009, which is a 371 application of PCT/BR2007/000096, filed Apr. 12, 2007, incorporated herein by reference.

### FIELD OF INVENTION

The present invention refers to an inventive solution for a management system of an ongoing financial transaction request, either credit or debit, the financial transaction request initiated by a registered remote customer or by a remote authorized dependent, where the consolidation of the purchase and payment by the supplied services is expedited.

### DESCRIPTION OF THE PRIOR ART

Financial transactions and operations, such as purchase and sale, have been made since the beginning of history. Following an evolution cycle of the monetary system, the commercial transactions started to be made, in a great number of commercial establishments, through electronic purchase terminals, due to the easy remote communication between the commercial establishments and the financial institution managing the debits and credits. However, to consolidate these commercial operations with these kinds of tool, the customer must be present at the shopping location or at a web terminal with his/her magnetic card. The shopkeeper needs to introduce the card physically in the electronic payment terminal to start the sale procedures or the information must be introduced into the purchase webpage.

Notwithstanding, the use of a magnetic card, chip card, Near Field Communication card or Near Field Communication phones in the present days presents several negative aspects, where the need of carrying it physically creates misleading and cloning conditions and, consequently, the undue use of the same.

On the other hand, financial transactions have already been made in a remotely way, confirming the trend of progressive substitution of the current physical layouts of the operational systems, by modern layouts, where the remote communication prevails. In this evolutionary line, the credit management systems are yet sluggish and difficult to operate, compelling the customer to adopt an exhaustively proactive behavior to consolidate the remote financial operation, thus infringing the basic principle of success of a new product. This will prevent the maintenance of a comfort zone previously defined to the customer-user.

In FIG. 1 an ordinary financial transaction of the prior art is shown, where a customer (1) physically initiates a financial transaction (5) by introducing or approaching, in case of a Near Field Communication technology, a credit or debit card into payment channel (2), such as a POS terminal, mobile phone and an ATM terminal; or physically enters the card information on an online purchase website of a computer machine. The payment channel sends a transaction information (6) to a payment platform (3), the information including, but not limited to the transaction information (value, type and date/time); the merchant information (terminal ID and merchant ID); the customer information (PIN, credit card type, credit card number, expiration date, security code and zipcode). The payment platform (3) further sends a payment information (7) to a financial institution (4) such as a bank or credit card issuer. The financial institution will then confirm all of the customer information; consolidate or refuse the transaction; and send a financial notification (8) back to the payment platform (3), which will then send a payment notification (9) to the payment channel, the payment channel finalizing the transaction with the customer, by sending a customer notification (10).

The financial transaction in this situation will only be possible if several requirements are met, starting with the customer be physically present in a payment channel location or in front of a computer with access to Internet. Further, the customer will necessary have to be physically carrying the credit/debit card and required to introduce it to a machine or punch the numbers into a buying terminal. The information will have to be sent all the way to a financial institution to be validated and returned to the payment channel, in order to be consolidated or refused. In order for a third person, who is authorized to initiate a financial transaction in connection with the customer's debit or credit card, such third person must posses the customer's card or be physically present in a payment channel location or in front of a computer with access to internet accompanying the customer.

In the risk side of the transaction, the volume of information sent via wireless in this system is greater and being of a greater risk of being stolen or cloned.

Accordingly, besides the accelerated technological advancement of the recent years, the prior art does not teach or describe a remote credit management system or a system for remotely managing an ongoing financial transaction, which is fast, reliable and practical at the same time.

U.S. Patent Application Pub. No. 2002/0038259 to Bergman describes a method and system for ordering and selling food at venues, in which a customer uses a communications device to create and send an order, the order is communicated to an order station 30, which may also communicate with one or more stadium or event vendors. Bergman is very clearly not a system wherein a reactive or passive action from a remote customer is requested to authorize or decline an ongoing financial transaction request being processed. The system in Bergman would also not allow an authorized person to initiate a financial transaction in connection with the customer account, without the customer being physically present.

U.S. Patent Application Pub. No. 2001/0037264 to Husemann simply describes a system for enabling a customer, who has access to a customer system and a mobile phone with associated phone number, to order a deliverable offered by a merchant system at a certain price, the merchant system accessed through the customer system and a network. Husemann also does not disclose or suggest a system wherein a reactive or passive action from a remote customer is requested to authorize or decline an ongoing financial transaction request being processed. The system would also not allow an authorized person to initiate a financial transaction in connection with the customer account, without the customer being physically present.

U.S. Patent Application Pub. No. 2002/0152135 to Beeri is directed to a system for providing a unified, single, integrated interface for performing e-commerce activities as purchasing products from different vendors, performing price comparison procedures, searching for products of interest and managing the purchase of different products from different vendors through e-commerce. Beeri thus also fails to teach or suggest wherein a reactive or passive action from a remote customer is requested to authorize or decline an ongoing financial transaction request being processed. The system would also not allow an authorized person to initiate a financial transaction in connection with the customer account, without the customer being physically present.

### SUMMARY OF THE INVENTION

The system for remotely managing an ongoing financial transaction of the present application fully provides the necessary comfort and speed of the customer-user, since the operations are characterized by a reactive or passive action from a registered remote customer. In the system of the present invention the customer is requested to authorize or refuse a financial transaction request being processed. The present system is an agile and simple fraud-proof system having low operational costs.

The present application seeks to provide a system for remotely managing an ongoing financial transaction, comprising: (a) a payment channel, receiving a financial transaction request; (b) a payment platform, receiving the financial transaction request from the payment channel; (c) a registered remote customer receiving the financial transaction request from the payment platform on an authentication device, the customer authenticating the financial transaction request to the payment platform on the authentication device; (d) a financial institution receiving the authenticated financial transaction request from the payment platform, and then authorizing or refusing the authenticated financial transaction request to the payment platform, and (e) the payment platform then sending an payment notification to the payment channel and to the authentication device, finalizing the transaction .

The present application seeks to provide a system for remotely managing an ongoing financial transaction, to be used between a shopkeeper or service supplier and a registered customer, using modern information technology. The system allows a registered customer be requested to authorize or refuse an ongoing transaction, even if such operation is being made by a third person duly authorized by the registered customer. The system presents a simplified architecture, being based in three main elements: (1) a customer with or without an authorized dependent authenticating the ongoing financial transaction; (2) a payment platform, such as a credit or debit central managing financial institution; and a (3) financial institution receiving the authenticated financial transaction request from the payment platform. The financial institution will authorize or refuse the authenticated financial transaction request to the payment platform, and the payment platform will sending an authentification notification to the payment channel and to the authentication device, also finalizing the transaction. Additionally, the financial transaction request may be initiated by the registered remote customer or by a remote authorized dependent.

The system of the present invention allows all kinds of financial operations to be restricted to these three elements, which communicate among themselves in a remotely way, using wireless communication.

### BRIEF DESCRIPTION OF THE DRAWINGS

FIG. 1 shows the architecture of a system for an ordinary financial transaction of the prior art.

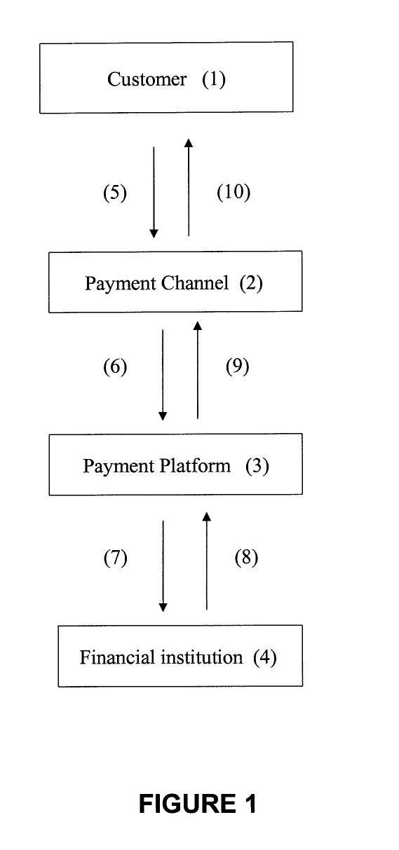

FIG. 2 shows the architecture of a system for remotely managing an ongoing financial transaction of the present application.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

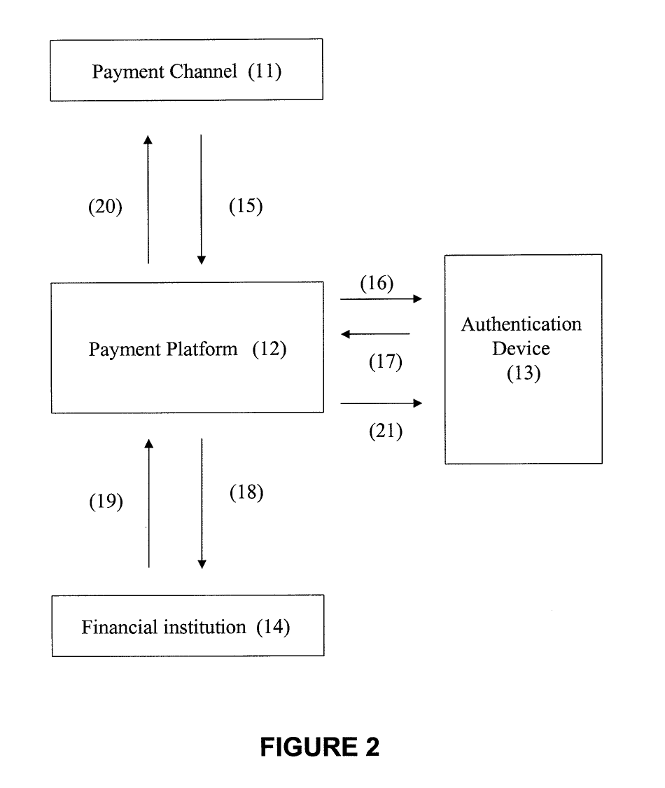

As it can be seen in FIG. 2, a payment channel (11), which can be chosen from a POS terminal, mobile phone acting as a POS terminal, e-commerce with payment check out capability, and ATM terminal receives a financial transaction request; the payment channel sends the financial transaction request (15) to a payment platform (12). The payment platform (12) sends then a payment transaction request (16) to an authentication device (13) of a registered remote customer, the registered remote customer authenticating the payment transaction request (17) to the payment platform on the authentication device. The authenticated financial transaction is then sent (18) to a financial institution (14) which may include banks and credit card issuers; the finacial institution authorizaing or refusing the authenticated financial transaction and then sending a financial notification (19) back to the payment platform (12), which will then send a payment notification (20) to the payment channel and to the authentication device (21), finalizing the transaction.

In the system of the present application the financial transaction request can be initiated by the registered remote customer or by a remote authorized dependent. When the remote authorized dependent starts the finacial transaction, in the same way, the payment platform (12) sends the a payment transaction request (16) to an authentication device (13) of the registered remote customer, who did not initiated the finacial transaction, the remote customer will remotely authorize or refuse the payment transaction request (17) through his/her authentication device.

In the system of the present application, the financial transaction request sent from the payment channel comprise the channel information, including but not limited to, terminal identification; transaction information, including amount, payment type, date and time; and the registered remote customer information, including the registered remote customer mobile or ID number. The payment platform is capable of storing the registered remote customer data and authenticating the registered remote customer via mobile operator and/or handheld application. The authentication device is a wireless communication device, and may include frequency modulation transmitter, software programs that are connected to the payment platform via Internet, freeware instant messaging client, interactive voice response systems, voice command or systems for oral solicitation by phone.

As for the authorization or refusing of the finacial transaction, the system allows the authorization or refusing of the financial transaction request by the registered remote customer to be done by a chosen secret code registered via mobile phone at the payment platform.

If necessary, the financial institution may send a statement with the summary of the sales to the payment channel after consolidating the financial transaction request.

Usage of the present invention on daily activities include:

Instore Transaction: Customer walks into the store, picks up a product and proceeds to the checkout. Cashier inputs the customer's mobile number at an ordinary POS terminal. Customer receives a payment authorization request at his/hers mobile device, including the option to choose one of the pre-registered credit/debit card. Customer chooses payment method and inputs password. The payment platform authenticates the customer, gathers the necessary payment information based on the card chosen, adds the merchant information and sends it to the financial institution. The financial institution authorizes or refuses the financial transaction and then sends the response to the payment platform, which then sends a confirmation to the authentication device and the POS terminal.

Web Transaction: Customer selects a product at the e-commerce and proceeds to check out. Customer only needs to input his/hers mobile number at the web site. Customer receives a payment authorization request at his/hers mobile device with the option to choose one of the pre-registered credit/debit card. Customer chooses payment method and inputs password. The payment platform authenticates the customer, gathers the necessary payment information based on the card chosen, adds the merchant information and sends it to the financial institution. The financial institution authorizes or refuses the financial transaction and then sends the response to the payment platform, which then sends a confirmation to the authentication device and the e-commerce.

ATM Withdrawal: A remote authorized dependent, such as family member for example, walks to an ATM terminal and selects withdrawal via mobile. After selecting the value, the user inputs the customer's mobile number. Customer receives a withdrawal authorization request at his/hers mobile device, including the option to choose one of the pre-registered credit/debit card. Customer chooses payment method and inputs password. The payment platform authenticates the customer, gathers the necessary payment information based on the card chosen, adds the ATM information and sends it to the financial institution. The financial institution authorizes or refuses the financial transaction and then sends the response to the payment platform, which then sends a confirmation to the authentication device and the ATM terminal.

Phone Transaction: Customer calls in to order food and at the end of the order provides the merchant with his/hers mobile number. The merchant inputs the customer's mobile number at the ordinary POS terminal. Customer receives a payment authorization request at his/hers mobile device, including the option to choose one of the pre-registered credit/debit card. Customer chooses payment method and inputs password. The payment platform authenticates the customer, gathers the necessary payment information based on the card chosen, adds the merchant information and sends it to the financial institution. The financial institution authorizes or refuses the financial transaction and then sends the response to the payment platform, which then sends a confirmation to the authentication device and the POS terminal.

Some clear advantages of the present invention include:

Privacy and Security: No financial information required to authorize a payment transaction. Customer only needs to provide the mobile number.

Secure Remote Authentication: even if customer is not present all transactions are password authorized by the customer on his/hers device wherever the customer is located.

Third party transaction: A remote authorized dependent, such as a family member, can withdraw money or shop and the transaction will be sent to the customer's mobile phone to be password authorized.

Mobile Marketing: during the authorization a coupon or a special offer can be sent to the customer's mobile phone and be accepted together with the payment request.

1. A system for remotely managing an ongoing financial transaction, comprising:
(a) a payment channel, receiving a financial transaction request;
(b) a payment platform, receiving the financial transaction request from the payment channel;
(c) a registered remote customer receiving a payment transaction request from the payment platform on an authentication device, the remote customer authenticating the payment transaction request to the payment platform on the authentication device;
(d) a financial institution receiving the authenticated payment transaction request from the payment platform, the financial institution authorizing or refusing the authenticated payment transaction request to the payment platform, and
(e) the payment platform sending a payment notification to the payment channel and to the authentication device, finalizing the transaction.

2. The system according to claim 1, wherein the financial transaction request is initiated by the registered remote customer or by a remote authorized dependent.

3. The system according to claim 1, wherein the payment channel is selected from the group consisting of: POS terminal; mobile phone acting as a POS terminal; e-commerce with payment check out capability and ATM terminal.

4. The system according to claim 3, wherein the payment channel is capable of requesting the registered remote customer mobile number.

5. The system according to claim 1, wherein the financial transaction request sent from the payment channel comprise the channel information, including terminal identification; transaction Information, including amount, payment type, date and time; and the registered remote customer information, including the registered remote customer mobile or ID number.

6. The system according to claim 1, wherein the payment platform is capable of storing the registered remote customer data and authenticating the registered remote customer via mobile operator and/or handheld application.

7. The system according to claim 1, wherein the authentication device is a wireless communication device selected from the group consisting of: frequency modulation transmitter; software programs that are connect to the payment platform via Internet; freeware instant messaging client; interactive voice response systems; voice command and systems for oral solicitation by phone.

8. The system according to claim 1, wherein the authentication of the payment transaction request by the registered remote customer is done by a chosen secret code registered via mobile phone at the payment platform.

9. The system according to claim 1, further including the financial institution sending a statement with a summary of the sales to the payment channel after consolidating the financial transaction request.
